(19) United States
(12) Patent Application Publication
(10) Pub. No.: US 2015/0224603 A1
(43) Pub. Date: Aug. 13, 2015

(54) FILLER CLOTH FOR LASER CLADDING

(71) Applicant: SIEMENS ENERGY, INC., ORLANDO, FL (US)

(72) Inventors: Gerald J. Bruck, Oviedo, FL (US); Ahmed Kamel, Orlando, FL (US)

(73) Assignee: SIEMENS ENERGY, INC., ORLANDO, FL (US)

(21) Appl. No.: 14/282,410

(22) Filed: May 20, 2014

Related U.S. Application Data
(63) Continuation-in-part of application No. 14/175,525, filed on Feb. 7, 2014.

(51) Int. Cl. B23K 35/02; B23K 35/36; B23P 6/00; B23K 35/00

(52) U.S. Cl. CPC B23K 35/0233; B23K 35/0238; B23K 35/0244; B23K 35/025; B23K 35/001; B23K 35/0255; B23K 35/36; B23P 6/00

(57) ABSTRACT

A preform (22A-F) containing metal (32, 34 36A-C, 38) and flux (33, 35, 37, 39A-C) for depositing a metal layer to a component being repaired or additively manufactured. The metal may be constrained in the preform in a distribution that creates a desired shape of the deposited metal in response to melting of the metal with an energy beam (46). The preform may be embodied as woven (22D) or unwoven (22B, 22C) cloth containing fibers of the flux, and fibers, particles or foil of the metal. It may contain at least 30 wt % fibers and at least 40% void fraction to enable flexibility and laser penetration. Alternating layers (32, 33) or flexible sintered sheets (36A-C, 37) of metal and flux fibers may be bound or laminated to form the preform. A woven preform may be made of alternating or crossing yarns (34, 35) of metal and flux.

This application is a continuation-in-part of U.S. patent application Ser. No. 14/175,525 filed on 7 Feb. 2014, (attorney docket 2014P02381 US) which is incorporated by reference herein.

### FIELD OF THE INVENTION

This invention relates generally to the field of solid freeform fabrication and repair of metal components, and particularly to additive layer fabrication and repair of high-temperature superalloy components.

### BACKGROUND OF THE INVENTION

Superalloy components such as gas turbine blades can develop defects including cracks and surface wear. Often such wear is theoretically repairable by removal of some volume of defective material and filling the removed volume with replacement metal via cladding techniques. However, airfoils and other complex shapes are difficult to clad because the repair requires controlling the delivery of process energy and filler material onto a 3D curved surface. Advanced laser scanning optics, such as galvanometer driven mirrors and other optical tools, can rapidly scan a laser beam in three dimensions. However, delivering the cladding filler material in three dimensions is difficult. Blowing of powder is inefficient. Even flat horizontal surfaces allow particulate scattering losses on the order of 40%. Surfaces inclined to the powder delivery direction cause even higher powder scattering losses of up to nearly 100%. Filler material may be delivered by feeding a solid wire to such inclined surfaces. However, the wire tip position must be precisely coordinated with the laser beam spot. A laser beam can move much more rapidly and precisely than a wire tip, so the wire slows processing and reduces precision.

Superalloy materials are among the most difficult materials to fabricate and repair due to their susceptibility to melt solidification cracking and strain age cracking. The term “superalloy” is used herein as it is commonly used in the art -- a highly corrosion and oxidation resistant alloy with excellent mechanical strength and resistance to creep at high temperatures. (see Wikipedia definition available at http://en.wikipedia.org/wiki/Superalloy) Superalloys typically include high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys. The term “metal” as used herein is meant to include pure metals as well as alloys of metal.

FIG. 1 illustrates the relative weldability of various alloys as a function of their aluminum and titanium content. Alloys such as Inconel® IN718 which have relatively lower concentrations of these elements, and consequentially relatively lower gamma prime content, are considered relatively weldable, although such welding is generally limited to low-stress regions of a component. Alloys such as Inconel® IN939 which have relatively higher concentrations of these elements have traditionally not been considered to be weldable, or to be weldable only with special procedures that increase the temperature/ductility of the material and minimize the heat input of the process. A dashed line 18 indicates a recognized upper boundary of a zone of weldability. The line 18 intersects 3 wt % aluminum on the vertical axis and 6 wt % titanium on the horizontal axis. Alloys outside the zone of weldability are recognized as being very difficult or impossible to weld with traditional processes, and the alloys with the highest aluminum content are generally found to be the most difficult to weld, as indicated by the arrow.

Selective laser melting (SLM) is the fusing of metallic particles in a powder bed by the application of localized laser heat to melt the powder and form a melt pool which solidifies as a consolidated layer of material that forms a solid cross section. When interaction of laser radiation with metal powder occurs, the energy deposition is highly dependent upon the energy coupling mechanism. Multiple reflections between unbound powder particles leads to higher optical penetration depths compared to solid material. However, versions of SLM suffer some or all of the following disadvantages:

a) Limited to processing on a flat horizontal surface in a chamber in order to retain the powder by gravity during laser processing.

b) Limited to weldable materials such as shown in FIG. 1.

c) A slow process, because each layer must be thin, such as 20 microns. Using thicker layers requires a higher energy density which can cause cracking.

d) Requires an inert shielding gas to avoid oxidation.

e) Requires preheating of the substrate and/or the powder to avoid cracking.

f) Limited usable beam energy density. An increase in energy density causes a larger degree of melting causing the material to form spherical balls rather than build a consistent layer.

g) Requires post-processing operations such as shot peening and hot isostatic pressing (HIP) to remove voids and contaminants.

h) Process is highly sensitive to powder production method.

Laser cladding is a solid freeform fabrication (SFF) process that deposits a metallic filler material onto the surface of a substrate to form a metal layer for repair or additive manufacture. A laser beam melts the surface of the substrate to form a melt pool into which the metallic filler material is continuously provided (e.g., pre-placed, fed ahead of, injected), thus forming a metal layer or cladding on the surface. One popular form of laser cladding uses powder that is pre-placed or fed ahead of the process location on the surface of the substrate. Various versions of laser cladding suffer some or all of the following disadvantages:

a) Slow process because each layer must be thin, such as 0.5 mm.

b) Even slower for materials that are hard to weld as shown in FIG. 1.

c) Requires an inert shielding gas to avoid oxidation.

d) Requires high preheating or fast cooling of the substrate to avoid cracking.

e) In some cases there is sensitivity to the powder production method.

As new superalloys are developed, there is a challenge to develop commercially feasible joining processes for superalloy materials. These joining processes have direct impact on repair and SFF applications for superalloys. Both SLM and laser cladding depend on the laser coupling efficiency, which depends on many factors, including powder size, powder quality and laser energy density. Powder sizes used in typical powder based processes are shown in FIG. 2 for plasma spray, high velocity oxygen fuel spray (HVOF), low pressure plasma spray (LPPS), cold gas spray, selective laser melting (SLM), combustion spray, plasma transferred arc spray, and laser cladding. The usable powder size distribution differs with process, and is distinct between SLM and laser cladding in particular. This constitutes a limitation on each of these processes for SFF of superalloys in terms of optimization of laser coupling and in customization of particle sizes for other reasons. Larger particles reduce process oxidation due to the lower surface area. Smaller particles provide finer definition of structural features in the component.

### BRIEF DESCRIPTION OF THE DRAWINGS

The invention is explained in the following description in view of the drawings that show:

FIG. 1 illustrates relative weldability of various superalloys.

FIG. 2 illustrates ranges of particle sizes for existing additive processes.

FIG. 3 is a perspective view of a preform.

FIG. 4 shows a preform with metal fibers and flux fibers mixed in a predetermined proportion forming a random 3-dimensional web or felt.

FIG. 5 shows a preform containing metal particles and flux fibers.

FIG. 6 is a top view of a preform with woven strands or yarns of metal and flux.

FIG. 7 shows a preform with alternating sheets of metal and flux.

FIG. 8 shows a preform with metal contained in pockets of flux.

FIG. 9 illustrates a process of solid freeform manufacturing using a preform.

FIG. 10 illustrates a repair process using a preform on a curved surface.

### DETAILED DESCRIPTION OF THE INVENTION

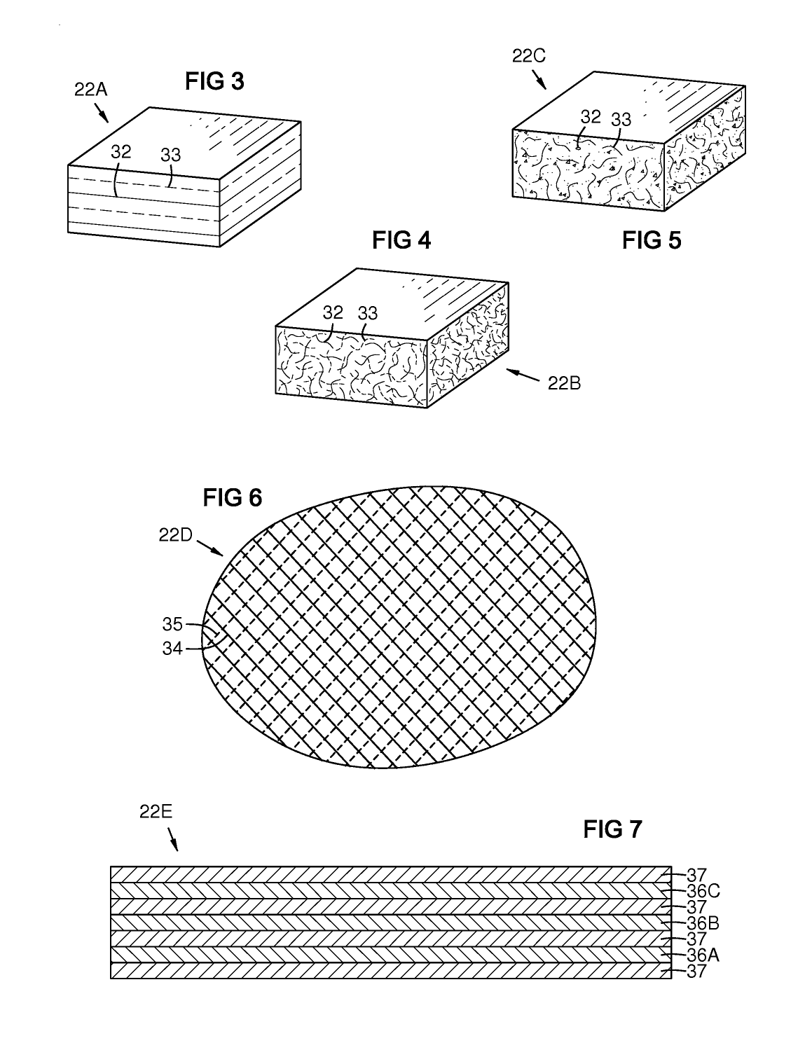

FIG. 3 shows a perspective view of a preform 22A embodied as a fabric containing fibers of metal 32 and flux 33. Flux materials may include alumina, carbonates, silicates, oxides, fluorides, and/or other compounds found in welding fluxes. The fabric may be woven or non-woven. In a non-woven preform, the metal and flux fibers may be deposited in alternating layers or mixed in a predetermined proportion to form a mat of discontinuous fibers. This may be fixed in a desired shape, for example by spark plasma sintering in a mold. The degree of sintering may be limited to fix a thickness and shape while preserving flexibility. The resulting preform may have a void fraction of at least 40%. This allows laser energy to penetrate into the preform between the fibers. The preform thickness may be uniform or it may be contoured to fit a depression formed in a component for repair. As an alternative to sintering, the ceramic cloth may be laminated with a flexible foil such as aluminum (ref. Rex Sealing & Packing), reinforced with metal wires (ref. Minseal by Shree Firepack) or strengthened with a binder such as latex (ref. Agis), vermiculite (ref. Rex Sealing & Packing) or ceramic cements such as phosphate, silicate (e.g. ethyl silicate) and magnesium oxysulfate (ref. Sauereisen) to bind the fibers sufficiently to hold a shape.

In one embodiment, fibers 32, 33 of the preform 22A may be heated in a mold or mixed in a liquid and dried in a mold, and the preform maintains its shape by mechanical interlocking in the random web of the fibers. Different additive materials may be contained in the same preform in different layers or in a gradient of materials. For example, a first layer may contain a structural superalloy, a second layer may contain a metallic bond coat, and a third layer may contain a ceramic thermal barrier material. Alternately, different additive materials may be deposited in a gradient when forming the preform. The preform may include a superalloy material and a flux material, and the metal is constrained in the preform in a distribution that creates a desired shape of a metal layer of a metal component in response to a melting of the metal with an energy beam.

FIG. 4 shows a preform embodiment 22B formed of metal fibers 32 and flux fibers 33 mixed in a predetermined proportion to form a random 3-dimensional web or felt. FIG. 5 shows a preform embodiment 22C formed of metal particles 32 and flux fibers 33 mixed in a predetermined proportion to form a random 3-dimensional web or felt of flux with embedded metal particles. Alternately, the particles may be flux and the fibers may be metal. Optionally, a gradient distribution of additive materials may be disposed in the preform, such as varying constituents of metal 32 and optionally ceramic. Forming at least a 30 wt % of the preform as randomly oriented fibers enables flexibility and maintains a desired void fraction.

FIG. 6 is a top view of a preform embodiment 22D formed of woven strands or yarns of metal 34 and flux 35. The respective metal and flux strands or yarns may have one or more of the following exemplary configurations:

a) The metal and flux be woven in respectively different directions as shown.

b) Metal and flux strands or yarns may alternate in each direction.

c) Each strand or yarn may contain a predetermined mixture of metal fibers and flux fibers.

d) The metal and flux strands or yarns may be woven in a pattern that creates a predetermined distribution and proportion of the metal and the flux in the preform.

Long fibers of one material can compensate for short fibers of another material to provide adequate fabric strength. This is useful for example when particles or short fibers of the metal or the flux are much less expensive than long fibers. For example where long metal fibers are expensive, flux fibers with a length/diameter ratio greater than 100 may be combined with metal particles and/or metal fibers with a length/diameter ratio of less than 30.

FIG. 7 shows a preform embodiment 22E formed of alternating metal sheets 36A-C and flux sheets 37. Each sheet may be woven or it may be formed from randomly oriented fibers bound as previously described, such as by limited spark plasma sintering that retains flexibility and a desired void fraction. In one embodiment, at least one of the metal sheets, such as bottom sheet 36A, may be formed of flexible metal foil. The metal foil may be embedded with metal or flux particles. The metal sheets and flux sheets may be stacked in alternating sequence then laminated by means such as spark plasma sintering or a binder to form a flexible conformable preform, which may have a void fraction of at least 40%. In one embodiment, sheets 36A, 36B, and 36C may comprise respectively different additive materials. For example 36A may comprise a structural superalloy, 36B may comprise a metallic bond coat material, and 36C may comprise a ceramic thermal barrier material.

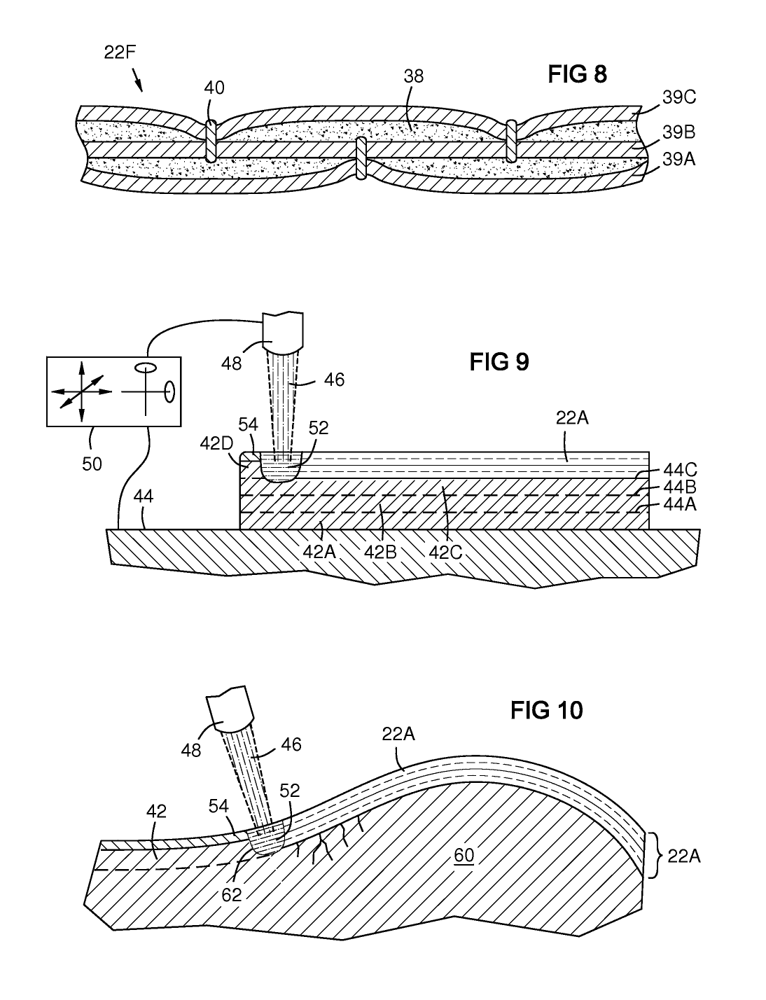

FIG. 8 shows a preform embodiment 22F with metal particles 38 contained in pockets formed by flexible sheets of flux 39A-C. The pockets may be formed by quilting or stitching 40, or by other means such as corrugations in the flux sheets formed with adhesive or 3D weaving. The flux sheets may have a fine enough mesh size to retain unbound particles of metal 38. Alternately, the pockets may be lined with paper, such as cellulose paper, which contributes to the flux, or metal foil, such as aluminum foil, which contributes to the superalloy. Some variation in thickness of the preform is tolerable, since the melt pool is self-leveling to some extent. Different pockets may contain particles of different sizes and/or different materials optimized for varying requirements over an area of a component being fabricated or repaired. In the embodiment shown, the pockets are offset from each other across a central sheet 39B to increase uniformity of the metal distribution.

FIG. 9 illustrates a process of additive fabrication using a preform embodiment 22A, although one will appreciate that other preform embodiments described above may be used. A component such as a gas turbine engine blade may be fabricated layer by layer 42A-D on a working surface 44. Each layer provides a new working surface 44A-C for the next layer, which is added by placing a preform 22A containing metal and flux on the last working surface 42C, and directing energy 46 such as a laser beam onto the preform. The original working surface 44 and/or the beam emitter 48 may be moved on multiple axes 50, and/or the beam 46 may be directed with mirrors to scan the preform. This forms a melt pool 52 along a beam path on the preform. The flux forms a slag blanket 54 on and around the melt pool, trapping heat, excluding oxygen, and scavenging impurities as it rises through the melt. For out of position processing (e.g. uphill, overhead, etc.) the melt is held in place by metal surface tension further assisted by molten slag surface tension and, upon solidification, solid slag representing a mold to contain molten metal.

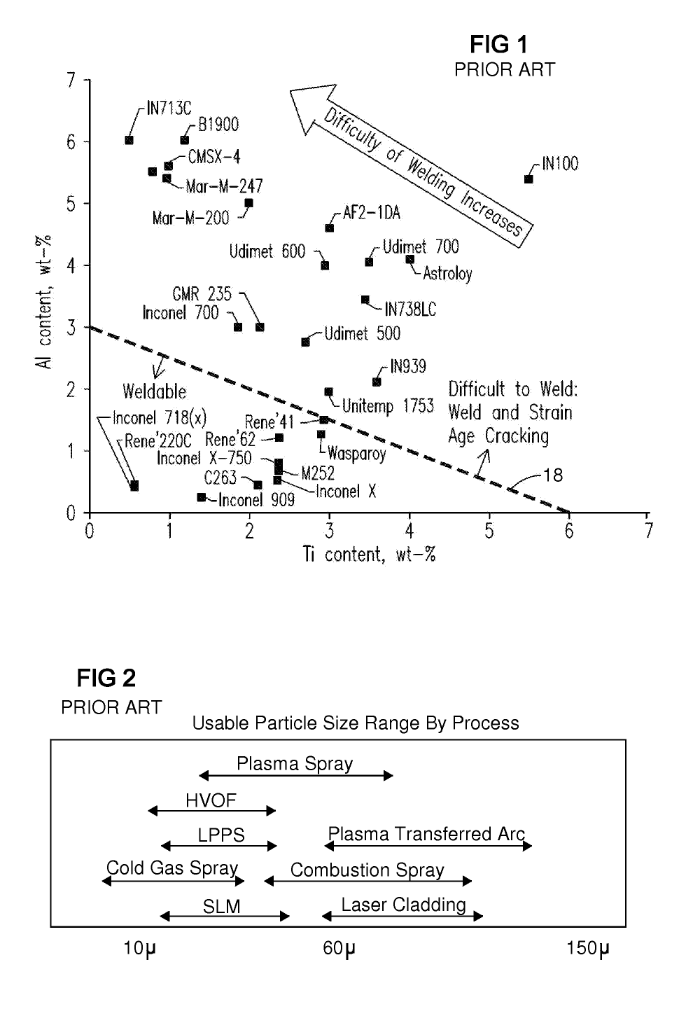

Any iron, nickel, or cobalt based superalloy used for high temperature applications such as gas turbine engines may be fabricated, joined, repaired, or coated with this method and apparatus, including superalloys outside the zone of weldability in FIG. 1. This is because the preform holds the feed material in place, protects it from air while at elevated temperature, scrubs impurities, and insulates it with a slag blanket for uniform and gradual cooling. This allows high-energy lasers to scan the preform at optimum speed, maintaining a stable melt front with uniform cooling.

FIG. 10 illustrates a process of repairing a component 60 that has a curved or non-horizontal surface 62 using a preform 22A conforming to the non-planar component surface. This illustrates a benefit of using preforms over open powder beds, which can slide on non-horizontal surfaces. The preform 22A and slag blanket 54 retain the melt pool 52 on all sides, allowing repair of surfaces that are not horizontal. For severely tilted surfaces, the preform 22A may initially be held in place by a tack weld, adhesive, mechanical fastener, etc.

The slag formed by the melted flux shapes and supports the deposit, preserves heat and slows the cooling rate, reducing residual stresses that otherwise contribute to strain age (reheat) cracking during post weld heat treatments. The flux may compensate for elemental losses in the superalloy or add alloying elements. Metal and flux pre-placement via a preform can reduce the time involved in total part building because it allows greater thickness of the deposit.

Repair processes for superalloy materials in accordance with embodiments of the present invention may include removal of degraded surface material and preparing a preform that matches the prepared surface. The energy beam is then traversed across the pre-placed preform to melt the powder and an upper layer of the substrate into a melt pool having a floating slag layer. This heals surface defects, leaving a renewed surface upon removal of the slag by known mechanical and/or chemical processes. The apparatus and process herein has the following advantages:

a) Can build on existing 3-D surfaces. Not limited to horizontal flat surfaces.

b) High maximum build rate, such as over 3 or 4 mm per layer.

c) Usable for metals that are difficult to weld.

d) Robust process that is adaptable to new damage modes.

e) No pre-heating or fast cooling needed.

f) Improved shielding that extends over the hot deposited metal without the need for inert gas. No shielding of the melt pool by inert gas is needed.

g) Allows a wide range of usable superalloys.

h) Flux enhanced cleansing of the deposit of constituents that otherwise lead to solidification cracking.

i) Flux enhanced laser beam absorption and minimal reflection back to processing equipment.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A preform for forming a layer of a component comprising:
a metal and a flux, wherein the metal is constrained in the preform in a distribution that creates a desired shape of a metal layer of a metal component in response to a melting of the metal with an energy beam.

2. The preform of claim 1, wherein the metal and flux are bound in a predetermined shape that is flexible and conformable to a curved surface.

3. The preform of claim 2, further comprising at least a 40% void fraction.

4. The preform of claim 1, wherein the metal and flux are disposed in the preform in a predetermined proportion that creates a metal layer with a blanket of slag in response to the melting, and the preform comprises at least 30 wt% of randomly oriented fibers.

5. The preform of claim 4, wherein the metal is disposed in particles and the flux is disposed in the randomly oriented fibers.

6. The preform of claim 1, wherein the metal is disposed in first strands or yarns of metal fibers, the flux is disposed in second strands or yarns of flux fibers, and the respective metal and flux strands or yarns are woven in a predetermined proportion that creates a metal layer with a blanket of slag in response to the melting.

7. The preform of claim 6, wherein the metal strands or yarns are woven in a first direction, and the flux strands or yarns are woven in a second direction.

8. The preform of claim 1, wherein the metal and flux are disposed in strands or yarns of mixed metal fibers and flux fibers that are woven to form the preform.

9. The preform of claim 8, wherein the metal fibers have a mean length/diameter ratio of less than 30, and flux fibers have a mean length/diameter ratio of greater than 100.

10. The preform of claim 1, wherein preform comprises a flexible sheet of the metal laminated to a flexible sheet of the flux, and the preform is conformable to a curved surface.

11. The preform of claim 10, wherein each of the flexible sheets is formed from a mat of randomly oriented fibers that is bound to a degree that retains at least a 40% void fraction in each sheet.

12. The preform of claim 1, wherein the metal is enclosed in pockets of the flux.

13. The preform of claim 1, wherein the flux forms a plurality of first and second pockets that overlap each other across a central sheet of the flux, and the metal is disposed as unbound particles in the pockets.

14. The preform of claim 1, wherein the metal comprises a superalloy composition that is beyond a zone of weldability defined on a graph of superalloys plotting titanium content verses aluminum content, wherein the zone of weldability is upper-bounded by a line intersecting the titanium content axis at 6 wt.% and intersecting the aluminum content axis at 3 wt. %.

15. A preform for a material deposition process, the preform comprising:
a first material in the form of fibers; and
a second material in the form of fibers or powder or foil;
wherein the first material comprises a metal or a flux, and oppositely, the second material comprises a flux or a metal.

16. The preform of claim 15, wherein both the first and second materials comprise fibers.

17. The preform of claim 16, wherein the first and second materials define respective distinct layers of the preform.

18. The preform of claim 15, wherein the first material comprises flux fibers and the second material comprises metal powder or metal foil.

19. The preform of claim 18, wherein the second material comprises the metal powder contained in a pocket formed between sheets of the flux fibers.

20. The preform of claim 15, further comprising a metal foil embedded with metal or flux particles.
